(19) United States
(12) Patent Application Publication
(10) Pub. No.: US 2025/0330827 A1
(43) Pub. Date: Oct. 23, 2025

(54) SYSTEM AND METHOD FOR NETWORK PLANNING BASED ON GEOGRAPHICAL BINNING OF KEY PERFORMANCE INDICATORS

(71) Applicant: Verizon Patent and Licensing Inc., Basking Ridge, NJ (US)

(72) Inventors: John N. Wakim, Salem, NH (US); Nusrat Kamal Burger, Burnsville, MN (US); Kyle Smith, Magnolia, TX (US)

(21) Appl. No.: 18/638,792

(22) Filed: Apr. 18, 2024

(51) Int. Cl. H04W 16/18; H04W 16/22; H04W 24/08

(52) U.S. Cl. CPC H04W 16/18; H04W 16/22; H04W 24/08

(57) ABSTRACT

A method, a device, and a non-transitory storage medium are described in which a radio access network (RAN) key performance indicator geographic normalization, decluster, and selection service is provided. The service may include automated new RAN device design, apportioning of geographic agnostic metrics associated with a RAN device to geo-bins, analyzing candidate geo-bins and associated candidate new RAN devices builds based on objective criteria, and iteratively calculating and ranking solutions that optimally satisfy the objective criteria. The service may also provide radio frequency propagation modeling for existing and new RAN device builds.

### BACKGROUND

Development and design of networks present certain challenges from a network-side perspective and an end device perspective. For example, Next Generation (NG) wireless networks, such as Fifth Generation New Radio (5G NR) networks are being deployed and under continuous development. One aspect of 5G NR and future wireless network development involves radio access network (RAN) management, planning, and optimization.

### BRIEF DESCRIPTION OF THE DRAWINGS

FIG. 1 is a diagram illustrating an exemplary environment in which an exemplary embodiment of a RAN key performance indicator (KPI) geographic normalization, decluster, and selection service may be implemented;

FIG. 2 is a diagram illustrating exemplary components of an exemplary embodiment of the RAN KPI geographic normalization, decluster, and selection service;

FIG. 3A is a diagram illustrating exemplary aspects of a candidate new radio site;

FIG. 3B is a diagram illustrating exemplary aspects of multiple candidate new RAN device sites;

FIG. 4A is a diagram illustrating an exemplary environment to which an exemplary process of an exemplary embodiment of the RAN KPI geographic normalization, decluster, and selection service may pertain according to an exemplary scenario;

FIG. 4B is a diagram illustrating an exemplary process of an exemplary embodiment of the RAN KPI geographic normalization, decluster, and selection service according to an exemplary scenario;

FIG. 5 is a diagram illustrating exemplary components of a device that may correspond to one or more of the devices illustrated and described herein;

FIG. 6 is a flow diagram illustrating an exemplary process of an exemplary embodiment of a RAN KPI geographic normalization, decluster, and selection service;

FIG. 7 is a flow diagram illustrating another exemplary process of an exemplary embodiment of a RAN KPI geographic normalization, decluster, and selection service; and

FIG. 8 is a flow diagram illustrating yet another exemplary process of an exemplary embodiment of a RAN KPI geographic normalization, decluster, and selection service.

### DETAILED DESCRIPTION

The following detailed description refers to the accompanying drawings. The same reference numbers in different drawings may identify the same or similar elements. Also, the following detailed description does not limit the invention.

RAN management, planning, and optimization is a highly complex endeavor for network operators, network management personnel, and the like. For example, the ability to understand network weak points, coverage gaps, poorly performing network devices, optimize existing network infrastructure, analyze prospective new radio site placements, calculate new radio or RAN device parameters and radio coverage areas, and the like can be technically challenging and complex. RAN management and planning systems may utilize inordinate amounts of data, address and solve multivariate problems, and attain multi-objective solutions for a radio site, a cluster of radio sites, and/or across the RAN.

According to exemplary embodiments, a RAN KPI geographic normalization, decluster, and selection service is described. According to an exemplary embodiment, the RAN KPI geographic normalization, decluster, and selection service may be applied to a RAN.

According to an exemplary embodiment, the RAN KPI geographic normalization, decluster, and selection service may include a geographic normalization service that may collect, translate, and normalize RAN geospatial data, as described herein. For example, the geographic normalization service may include assigning identifiers, coordinates, apportionment values, and terrain values, as described herein. In this way, the RAN KPI geographic normalization, decluster, and selection service may apply and apportion geographic and non-geographic data (e.g., KPIs) on a per-geo-bin basis, as described herein.

According to an exemplary embodiment, the RAN KPI geographic normalization, decluster, and selection service may include a RAN device placement service that may calculate new RAN deployment builds based on the normalized geo-bins, current and planned radio site locations, and geospatial declustering algorithm that provides a solution set for new RAN device placement across varying radio site densities and the normalized geo-bins associated with a given geographic region, as described herein.

According to an exemplary embodiment, the RAN KPI geographic normalization, decluster, and selection service may include an automated network design service that may calculate existing RAN device builds and their respective radio configurations (e.g., antenna characteristics, boresight, tilt, etc.) and radio coverages, apply the calculated existing RAN devices and coverages to the solution set for new RAN device placement in view of the normalized geo-bins, and calculate new RAN device design, configurations, and predictive radio frequency propagation, coverage, and various signal metrics (e.g., path loss, signal-to-noise ratio (SNR), signal strength, received power, received quality, etc.) associated with each new RAN device and normalized geo-bin, as described herein.

According to an exemplary embodiment, the RAN KPI geographic normalization, decluster, and selection service may include a decomposition, decluster, and selection service that includes assigning non-geographic KPIs (e.g., network resource capacity/utilization, dropped calls, wait times, or another type of network measurement) to normalized geo-bins associated with an existing RAN device. According to an exemplary embodiment, the RAN device may be selected based on a signal metric value (e.g., highest received power and/or another signal metric value) attributable to the RAN device and potentially relative to other possible candidate RAN device(s). According to an exemplary embodiment, the decomposition, decluster, and selection service may include selecting a new RAN device placement for a RAN device based on one or more objective criteria. For example, the objective criterion may relate to maximizing radio coverage, maximizing SINR, and/or another type of desired metric (e.g., maximizing or minimizing another type of performance data metric, as described herein). The decomposition, decluster, and selection service may include declustering and ranking candidate new RAN device placement locales, as described herein. For example, the decomposition, decluster, and selection service may select normalized geo-bins, which satisfy the objective criterion or criteria, as candidate new RAN device locations. In this way, the RAN KPI geographic normalization, decluster, and selection service may provide a specific geo-bin locale and new RAN device configuration that addresses a specific objective criterion or criteria.

In view of the foregoing, the RAN KPI geographic normalization, decluster, and selection service may improve network management, planning, and optimization tasks pertaining to a RAN. For example, the RAN KPI geographic normalizing, declustering, and selection service may enable application of non-geographic KPIs to be considered at a geo-bin level for new RAN device placement selection, new RAN device configuration, network optimization with existing RAN deployment, and so forth.

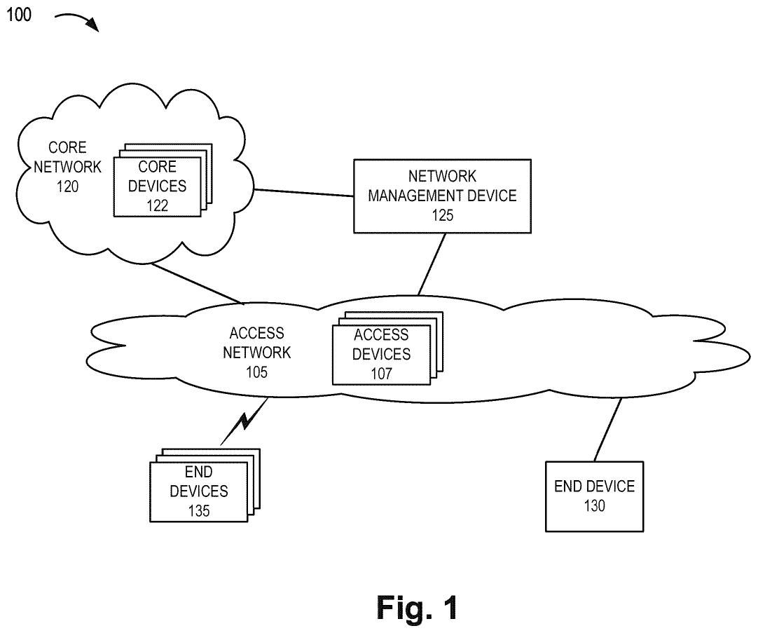

FIG. 1 is a diagram illustrating an exemplary environment 100 in which an exemplary embodiment of RAN KPI geographic normalization, decluster, and selection service may be implemented. As illustrated, environment 100 includes an access network 105 and a core network 120. Access network 105 may include access devices 107 (also referred to individually or generally as access device 107). Core network 120 may include core devices 122 (also referred to individually or generally as core device 122). Environment 100 may include a network management device 125 and an end device 130. Environment 100 may further include end devices 135 (also referred to individually or generally as end device 135).

The number, type, and arrangement of networks illustrated in environment 100 are exemplary. For example, according to other exemplary embodiments, environment 100 may include additional networks and/or different networks. For example, according to other exemplary embodiments, other networks not illustrated in FIG. 1 may be included, such as an X-haul network (e.g., backhaul, mid-haul, fronthaul, etc.), and/or a transport network (e.g., Signaling System No. 7 (SS7), etc.).

Additionally, or alternatively, environment 100 may include an external network, or another type of network that may support a wireless service and/or provide an application service, as described herein. For example, the core network may include a complementary network of access network 105, such as a 5G core network, an evolved packet core (EPC) of a Long Term Evolution (LTE) network, an LTE-Advanced (LTE-A) network, and/or an LTE-A Pro network, a future generation core network (e.g., a 5.5G, a Sixth Generation (6G), a Seventh Generation (7G), or another generation of core network), and/or another type of core network. Also, for example, the external network may be implemented to include a service or an application layer network, a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software defined network (SDN), a virtual network, a packet-switched network, a data center, or other type of network that may provide access to and may host an end device application service, such as IoTs (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), voice, conferencing, instant messaging), video streaming, and/or other types of wireless and/or wired application services.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into various types of network architectures (e.g., SDN, virtual, logical, network slice, etc.). The number, the type, and the arrangement of network devices (e.g., access devices 107, network management device 125, etc.), end device 130, and end devices 135 are exemplary.

Environment 100 includes communication links between the network devices, and between end device 130 and the network/network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication.

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), and/or another type of access network. Access network 105 may include a legacy RAN (e.g., a Third Generation (3G) RAN, a Fourth Generation (4G) or 4.5 RAN, etc.). Access network 105 may communicate with and/or include other types of access networks, such as, for example, a WiFi network, a Worldwide Interoperability for Microwave Access (WiMAX) network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105, as well as other types of networks (e.g., an external network, a core network, etc.).

Access network 105 may include different and multiple functional splitting, such as options 1, 2, 3, 4, 5, 6, 7, or 8 that relate to combinations of access network 105 and a core network including, for example, an evolved packet core (EPC) network and/or an 5G core network, or the splitting of the various layers (e.g., physical layer, medium access control (MAC) layer, radio link control (RLC) layer, packet data convergence protocol (PDCP) layer, and/or other layers), plane splitting (e.g., user plane, control plane, etc.), a centralized unit (CU) and distributed unit (DU), interface splitting (e.g., F1-U, F1-C, E1, Xn-C, Xn-U, X2-C, Common Public Radio Interface (CPRI), etc.) as well as other types of network services, such as dual connectivity (DC) or higher, carrier aggregation (CA), edge and core network slicing, coordinated multipoint (COMP), various duplex schemes, and/or another type of connectivity service (e.g., non-standalone (NSA) new radio (NR), stand-alone (SA) NR, and the like).

According to some exemplary embodiments, access network 105 may be implemented to include various architectures of wireless service, such as, for example, 5G, macrocell, microcell, femtocell, picocell, metrocell, NR cell, Long Term Evolution (LTE) cell, non-cell, 6G or beyond, or another type of cell architecture. Additionally, according to various exemplary embodiments, access network 105 may be implemented according to various wireless technologies (e.g., RATs, etc.), and various wireless standards, frequencies, bands, carrier frequencies, and segments of radio spectrum (e.g., cm wave, mm wave, below 6 gigahertz (GHz), above 6 GHz, higher than mm wave, C-band, licensed radio spectrum, unlicensed radio spectrum), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an evolved LTE (eLTE) evolved Node B (eNB), an eNB, a radio network controller (RNC), a remote radio head (RRH), a baseband unit (BBU), a radio unit (RU), a centralized unit (CU), a CU control plane (CU CP), a CU user plane (CU UP), a distributed unit (DU), a small cell node (e.g., a picocell device, a femtocell device, a microcell device, a home eNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), another type of wireless node (e.g., a WiFi device, a WiMax device, a hotspot device, etc.) that provides a wireless access service, or another type of network device that provides a transport service (e.g., routing and forwarding), such as a router, a switch, or another type of layer 3 (e.g., network layer of the Open Systems Interconnection (OSI) model) network device. Additionally, or alternatively, access device 107 may include a wired and/or optical device (e.g., modem, wired access point, optical access point, Ethernet device, etc.) that provides network access.

Core network 120 may include one or multiple networks of one or multiple network types and technologies. Core network 120 may include a complementary network of access network 105. For example, core network 120 may be implemented to include a 5G core network, an evolved packet core (EPC) network of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM), a unified data repository (UDR), an authentication server function (AUSF), a security anchor function (SEAF), a network exposure function (NEF), a network slice selection function (NSSF), a network repository function (NRF), a policy control function (PCF), a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

Network management device 125 may include logic that provides one or multiple operations, in whole or in part, of an exemplary embodiment of the RAN KPI geographic normalization, decluster, and selection service, as described herein. Although network management device 125 is depicted outside of access network 105, such an illustration is exemplary. According to other exemplary implementations, network management device 125 may or may not reside in access network 105. According to various exemplary embodiments, network management device 125 may be included in and/or communicatively coupled to an operations support system (OSS), a business support system (BSS), a network management system, a network performance management system, or the like.

End device 130 may include logic that provides one or multiple operations, in whole or in part, of an exemplary embodiment of the RAN KPI geographic normalization, decluster, and selection service, as described herein. End device 130 may be implemented as a computer, such as a desktop, a laptop, a terminal, or the like, for example. In this regard, according to some exemplary embodiments, the RAN KPI geographic normalization, decluster, and selection service may be cooperatively implemented by end device 130 and network management device 125. For example, end device 130 may include a client (e.g., client software) that may communicatively couple end device 130 to network management device 125. The client may further support a user interface (e.g., a graphical user interface and/or another type of interface). According to other exemplary embodiments, the RAN KPI geographic normalization, decluster, and selection service may be implemented by only end device 130 or only network management device 125. According to such exemplary embodiments, environment 100 may not include end device 130 or network management device 125.

End device 135 may include a device that may have computational and/or communication capabilities (e.g., wireless, wired, optical, etc.). End device 135 may be implemented as a mobile device, a portable device, a stationary device (e.g., a non-mobile device and/or a non-portable device), a device operated by a user, or a device not operated by a user. For example, end device 135 may be implemented as a smartphone, a mobile phone, a personal digital assistant, a tablet, a netbook, a wearable device (e.g., a watch, glasses, etc.), a computer, a gaming device, a music device, an IoT device, a drone, a smart device, or other type of wireless device (e.g., other type of user equipment (UE)). End device 135 may be configured to execute various types of software (e.g., applications, programs, etc.). The number and the types of software may vary among end devices 135. End devices 135 may include “edge-aware” and/or “edge-unaware” application service clients. End device 135 is not to be considered a network device, as described herein. End device 135 may be associated with a user that subscribes to a wireless service of access network 105.

End device 135 may support one or multiple RATs (e.g., 4G, 5G, and/or future generation RAT) and various portions of the radio spectrum (e.g., multiple frequency bands, multiple carrier frequencies, licensed, unlicensed, mm wave, above mm wave, cm wave, etc.), various levels and genres of network slicing, DC service, CA service, and/or other types of connectivity services. Additionally, end device 135 may include one or multiple communication interfaces that provide one or multiple (e.g., simultaneous, interleaved, etc.) connections via the same or different RATs, frequency bands, carrier frequencies, network slices, and/or via another communication medium (e.g., wired, etc.). The multimode capabilities of end device 135 may vary among end devices 135.

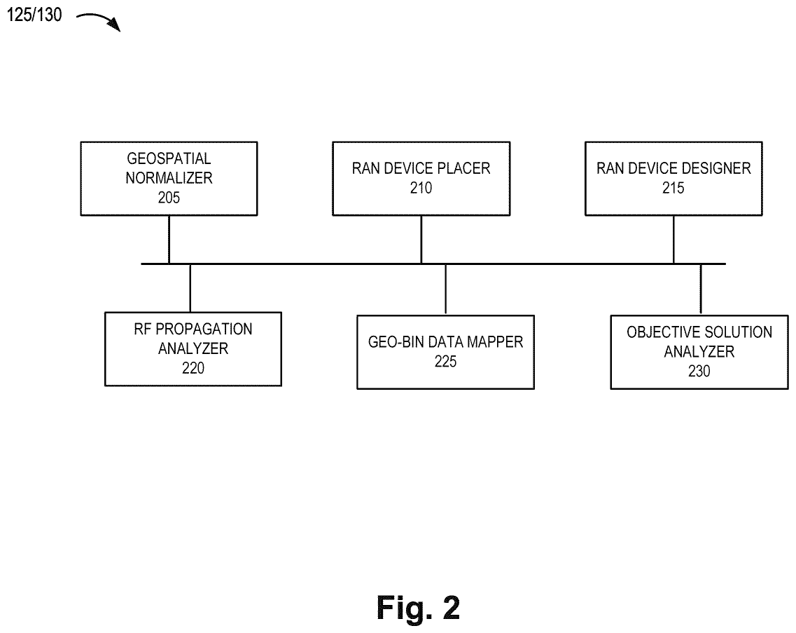

FIG. 2 is a diagram illustrating exemplary components of an exemplary embodiment of the RAN KPI geographic normalization, decluster, and selection service. One or more of the components may be implemented by network management device 125, end device 130, or both, and may each perform one or more operations, functions, and/or a sub-service, in whole or in part, of the RAN KPI geographic normalization, decluster, and selection service, as described herein. As illustrated, network management device 125 and/or end device 130 may include a geospatial normalizer 205, a RAN device placer 210, a RAN device designer 215, an RF propagation analyzer 220, a geo-bin data mapper 225, and an objective solution analyzer 230. Two or more of geospatial normalizer 205, RAN device placer 210, RAN device designer 215, RF propagation analyzer 220, geo-bin data mapper 225, and/or objective solution analyzer 230 may be communicatively coupled to each other. Additionally, two or more of geospatial normalizer 205, RAN device placer 210, RAN device designer 215, RF propagation analyzer 220, geo-bin data mapper 225, and/or objective solution analyzer 230 may each provide a sub-service, as described herein, based on one or more other sub-services associated with one or more other components of the RAN KPI geographic normalization, decluster, and selection service.

According to other exemplary embodiments, the RAN KPI geographic normalization, decluster, and selection service may be implemented by additional, different, and/or fewer components than those illustrated and described. For example, one or more components may be combined and/or one or more operations, functions, and/or subservices may be divided into multiple or dedicated components not illustrated.

Geospatial normalizer 205 may include logic that includes ingesting, translating, and normalizing various types of RAN geospatial data. The geospatial data may include diverse types of data, such as map data, live data feeds, geographic coordinate data (e.g., latitude, longitude, azimuth, etc.), geographic data of a Military Grid Reference System (MGRS) or another type of grid system that produces geo-bins, terrain data, Voronoi-based area data, and the like. Geospatial normalizer 205 may normalize the different types of geospatial data into a common format. Geospatial normalizer 205 may include further logic that performs other types of data processing procedures, such as tagging and apportioning, as described herein. For example, geospatial normalizer 205 may include generating and associating different types of identifiers. For example, the identifiers may include unique geo-bin identifiers that identify geo-bins, geo-bin centric identifiers that identify center locations (e.g., coordinates or the like) of the geo-bins, and target geographic identifiers that may identify a geographic area, such as a zip code, a town, a city, a county, a province, a state, a district, a popular region or neighborhood (e.g., Times Square, Back Bay area), a landmark area, or another type of geographic region, which may be associated with or correlated to a set of one or multiple geo-bins.

Geospatial normalizer 205 may include generating and associating other types of data relating to the geo-bins. For example, geospatial normalizer 205 may apportion a configurable metric (e.g., number of people or another type of metric) to the geo-bins. As an example, assume the geographic identifier relates to a zip code. Geospatial normalizer 205 may apportion the population within the zip code to each geo-bin of the zip code. In this way, each geo-bin may be associated with a portion of the overall population of the zip code.

Geospatial normalizer 205 may generate and associate other forms of data relating to the geo-bins, such as objects (e.g., trees, buildings, streets, attributes of terrain, etc.), characteristics of the objects (e.g., height, type, etc.), and different values associated with the characteristics (e.g., minimum, maximum, average (e.g., in terms of height, type, etc.)).

RAN device placer 210 may include logic that identifies geo-bins hosting existing RAN devices (e.g., an RU, an RU+DU, an RU+DU+CU, a gNB, an eNB, an RF transmitter/receiver, etc.), geo-bins identified for future RAN device builds, and geo-bins that are not designated for future RAN builds but are suitable for RAN device builds (collectively referred to as seeded locations), and geo-bins that are not designated for future RAN builds but uncertain whether such geo-bins are suitable for future RAN device builds (also referred to as non-seeded locations), for example.

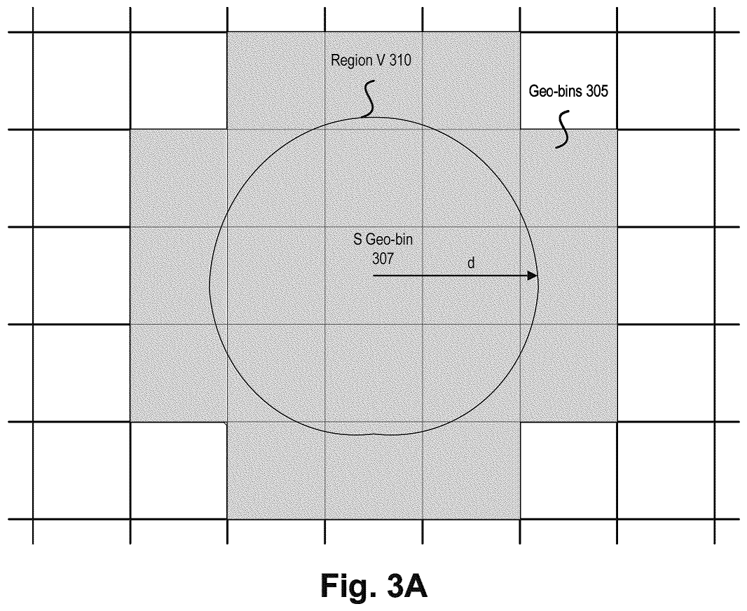

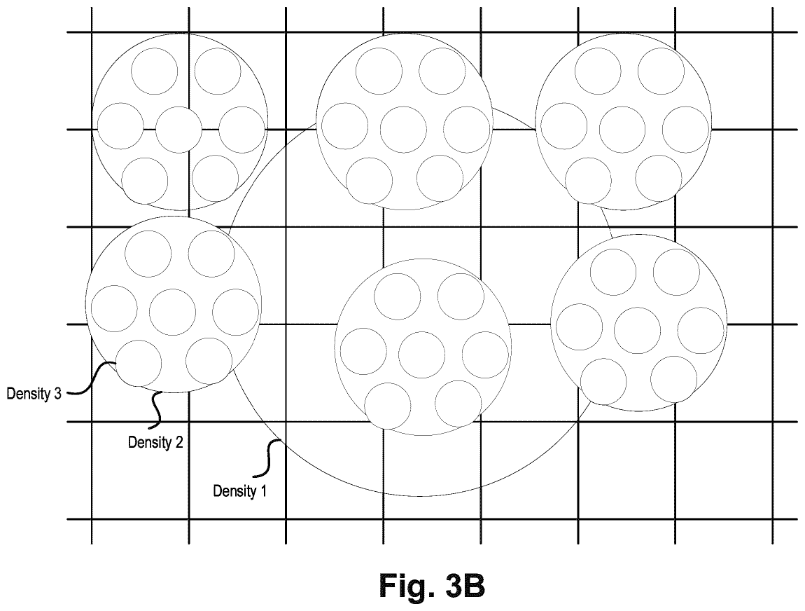

RAN device placer 210 may calculate inter-site distances for the seeded locations. For example, an inter-site distance may be a distance outward from the center coordinate of a geo-bin. The inter-site distance may be used to manage density of RAN devices within a given geographic area and may impact the type of future RAN device, such as a high density may include a number of small-powered cell sites versus a low density may include a high powered or macro cell site. The geographic density region may include multiple geo-bins and may include one or multiple existing RAN devices. For example, an S geo-bin 307 associated with a seeded location is illustrated in FIG. 3A, in which a distance d from a center location of S geo-bin 307 is depicted and may form a density region V. Geo-bins 305 may indicate geo-bins impacted by a future RAN device build at S geo-bin 307.

RAN device placer 210 may calculate across the seeded locations, with varying inter-site distances and density regions relating to future RAN device placement locales. For example, as illustrated in FIG. 3B, RAN device placer 210 may calculate varying density regions (e.g., in terms of size), such as density 1, density 2, and density 3, with particular S geo-bins, distance d, and geo-bins 305 (not illustrated). According to other exemplary scenarios, the number of different densities may be fewer than 3 or any number greater than 3.

RAN device placer 210 may decluster and rank the candidate future RAN placement sites based on a configurable parameter. For example, assume that the parameter relates to population density within geo-bins pertaining to the candidate future RAN placement site. RAN device placer 210 may sort and rank the future candidate RAN device placement sites that satisfy the population density parameter (e.g., highest to lowest, lowest to highest). RAN device placer 210 may discard non-buildable or inappropriate locations (e.g., body of water, zoning restriction for a particular RAN device deployment, such as a large macro RAN device, population density below a threshold value, etc.). As a result, RAN device placer 210 may provide a catalog of future candidate RAN device placement site locales within a given area. The catalog may relate to locales having the same density or different sets of locales having different densities, values of d, etc., as described herein. According to some exemplary embodiments, the given area may be all of the United States. According to other exemplary embodiments, the given area may be a smaller geographic area or a larger geographic area (e.g., multi-country, a continent, multi-continent, global, etc.).

RAN device designer 215 may include logic that calculates for the seeded locations with existing RAN devices or planned for future build RAN devices their respective RAN device characteristics. RAN device designer 215 may consider factors, such as region, equipment vendor, site type (e.g., macro, small, mid-size, etc.), morphology (e.g., downtown city, rural, etc.), and other types of relevant information relating to the RAN device. RAN device designer 215 may evaluate attributes associated with an antenna (e.g., height, vertical/horizontal beamwidths, transmittable frequencies, downtilt, antenna boresight, etc.).

RAN device designer 215 may calculate, in an automated manner, new RAN device builds based on the RAN device builds and characteristics (e.g., existing, already planned and designed) associated with the seeded locations. For example, RAN device designer 215 may construct or generate a new RAN device with a given set of RAN device characteristics (e.g., including antenna characteristics, type of RAN device (e.g., macro, small, eNB, gNB, RU, etc.) to be situated in a candidate future RAN device location/geo-bin. The selection and use of existing or already planned/designed RAN devices to generate the new RAN device build may be based on a maximum distance or minimal proximity from the new RAN device site, among other configurable parameters. Additionally, or alternatively, the selection and use of existing or already planned/designed RAN devices may be based on other parameters, such as matching a density value associated with the new RAN device, matching a density value and one or multiple antenna characteristics (e.g., azimuth, horizontal beamwidth, etc.). RAN device designer 215 may be configured to infer from an iterative feedback loop new RAN device builds that may maximize an objective criteria for any or every candidate new RAN device site, as described herein.

RF propagation analyzer 220 may include logic that performs RF propagation modeling relative to the new RAN devices, geo-bins of relevance, and existing/already planned RAN devices. RF propagation analyzer 220 may include obstruction calculations relating to a new RAN device, geo-bins, and a receiver (e.g., 2D geo-bin based rays). RF propagation analyzer 220 may include 3D geo-bin based ray calculations, line-of-sight calculations between transmitter and receiver via geo-bins, and calculations of Fresnel zones. RF propagation analyzer 220 may consider topography changes and terrain changes (e.g., new housing development, seasonal changes regarding vegetation, etc.) relating to geo-bins and their impact on RF transmission and reception.

RF propagation analyzer 220 may further include logic that calculates additional RF characteristics based on the normalized geo-bins, the candidate new RAN devices placement sites, the new RAN device characteristics/builds, and RF propagation modeling, as described herein. For example, RF propagation analyzer 220 may include calculations relating to pathloss (e.g., between RF transmitter and RF receiver), and other types of signal metrics, such as Signal-to-Noise Ratio (SNR), Reference Signal Received Power (RSRP), and/or other types of metrics, such as Signal-to-Interference-plus Noise Ratio (SINR), SNIR, Reference Signal Received Quality (RSRQ), Received Signal Strength Indicator (RSSI), or the like.

According to an exemplary embodiment, RF propagation analyzer 220 may assign or associate with each candidate new RAN device location/geo-bin the pathloss and other types of signal metrics (e.g., SNR, RSRP, obstruction, etc.), as described herein. RF propagation analyzer 220 may perform the aforementioned calculations across one or multiple frequency bands, carrier frequencies, etc., as described herein.

RF propagation analyzer 220 may also obtain and/or calculate pathloss and signal metric values associated with geo-bins of radio coverage areas for existing RAN devices in relation to end devices 135. According to some exemplary embodiments, access devices 107 and/or core device 122 (e.g., NWDAF, network performance system, or the like) may provide various signal metric values to network management device 125.

Network management device 125 may also obtain or collect other data relating to access network 105, existing access devices 107, and end devices 135, such as performance metric data. For example, the performance metric data may include values pertaining to throughput (e.g., uplink, downlink), bit rate (e.g., guaranteed, maximum, minimum, etc.), latency, data volume, packet error rate, packet drop rate, jitter, random access failures, average uplink interference, Radio Resource Control (RRC) setup failures, handover attempts, handover failures, radio bearer drops, retries, percentage of use of sub-optimal modulation schemes (e.g., Quadrature Phase Shift Keying, etc.), key performance indicators (KPIs), Quality of Service (QOS) values, Quality of Experience (QoE) values, service level agreement (SLA) values, Mean Opinion Score (MOS) values, and/or the like. Network management device 125 may also obtain or collect performance metric data from core devices 122 and other networks, as described herein.

Geo-bin data mapper 225 may include logic that maps or correlates data to the geo-bins, such as geographic-based network data (e.g., performance metric data, distance histogram-based (timing advance) measurements, etc.). According to some exemplary embodiments, the geographic-based network data may relate to location or positioning information of end device 130 (and associated geo-bin), access device 107 (e.g., existing RAN device, candidate new RAN device, etc.), radio coverage areas of existing RAN device, candidate new RAN device, geo-bins of existing RAN device, geo-bins of candidate new RAN device, etc.

Geo-bin data mapper 225 may utilize and/or calculate other forms of data, such as non-network KPI models. Examples of non-network KPI models may include spectrum license compliance, population covered, service gap fill-in, urban sprawl, state and metro geogrids, and other types of geo-grids (e.g., sector priority, coverage per band, etc.).

Geo-bin data mapper 225 may further include logic that calculates non-geographic network data in relation to the geo-bins based on the performance metric data. Examples of non-geographic network data may include dropped calls, network resource utilization, wait times, and other types of network data that may be attributable to access device 107 but not ascribed to the radio coverage area of access device 107 on a per geo-bin basis (e.g., non-geo-bin specific). For example, a dropped calls value may relate to a sector of a RAN device, but the dropped calls value does not indicate dropped calls on a per geo-bin basis (e.g., in which the sector may include two or more geo-bins). Geo-bin data mapper 225 may map or correlate the calculated non-geographic network data to the geo-bins, as described herein.

According to an exemplary embodiment, geo-bin data mapper 225 may calculate a geo-bin apportionment value on a per geo-bin basis for a non-geographic network data value based on performance metric data. For example, as described herein, geo-bin data mapper 225 may select one or multiple types of performance metric data in relation to geo-bins of relevance that may relate to the non-geographic network data value. For example, performance metric data values, such as received power values associated with geo-bins of a sector of a RAN device may be a root cause of, have a causal or a statistical (e.g., correlative) relationship with, a contributor to, and/or indicator of a non-geographic network data value, such as a dropped call value.

According to exemplary embodiment, geo-bin data mapper 225 may calculate a geo-bin apportioned value for geo-bins of a RAN device based on the following exemplary expression:

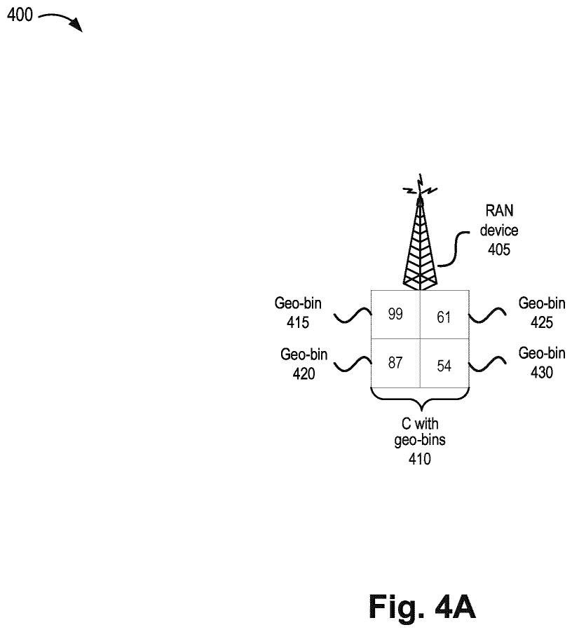

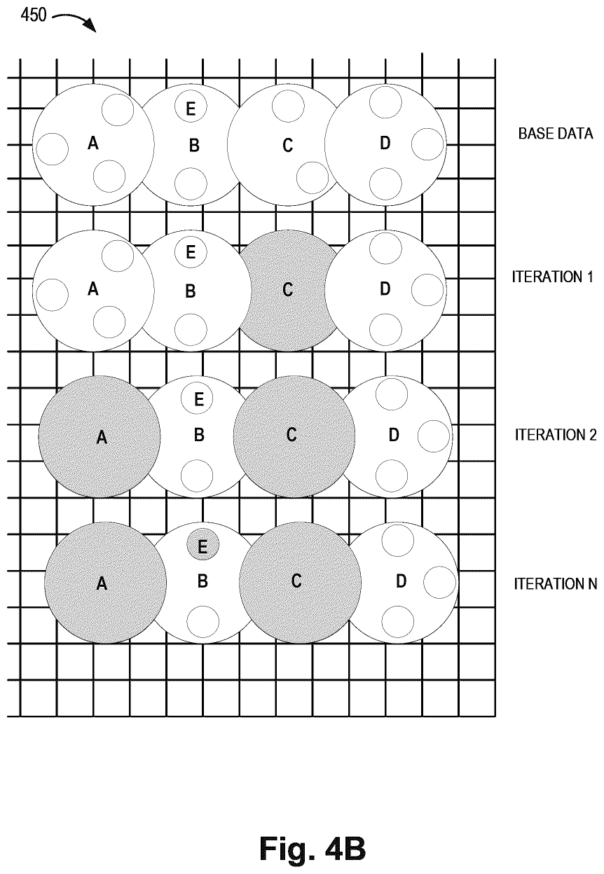

Geo-bin apportionment=N*(W/Sum(W_c)) (1),

in which Nis a network measurement, W is a weight associated with performance metric data values associated with geo-bins of C, and C is a radio coverage area including the geo-bins. W_c is the respective weight associated with each geo-bin of radio coverage area C. Referring to FIG. 4A, an exemplary case pertaining to the geo-bin apportionment is illustrated and described. According to this example, assume that that the non-geographic network data is wait time and the performance metric data values include forward data volume (FDV) and user perceived throughput (UPTP), such that the weight for each geo-bin is calculated according to the following exemplary expression:

W=FDV/UPTP (2),

in which FDV may have a unit of measurement of data size, such as Megabytes (MB), Gigabytes (GB) or another unit for data size, and UPTP may have a unit of measurement of data size/time, such as MB/second, etc.

As illustrated, an exemplary environment 400 includes access device 107 (e.g., RAN device 405) that has a radio coverage area C that includes geo-bins 410. As further illustrated, each geo-bin of geo-bins 410 may be associated with a W value based on expression (2). According to this example, assume that the wait time is 8 seconds in relation to C. Referring to expressions (1) and (2), the following calculation may be performed for geo-bin 415 as follows:

Geo-bin apportionment=N*(W/Sum(W_c))

Geo-bin apportionment=8*(99/(99+61+87+54))

Geo-bin apportionment=8*(99/30)

Geo-bin apportionment=˜2.6 seconds

For the sake of description, for a geo-bin 420, a geo-bin 425, and a geo-bin 430, the geo-bin apportionment values of wait time may be calculated in a similar manner that yield wait time values of approximately 2.3 seconds, 1.6 seconds, and 1.4 seconds, respectively.

Objective solution analyzer 230 may include logic that selects a new RAN device site (e.g., geo-bin) for a new RAN device based on one or more objective criteria. For example, the objective criterion may relate to maximizing radio coverage, maximizing SINR, maximizing population covered, and/or another type of desired metric (e.g., performance metric data), such as maximizing throughput, minimizing latency, packet error rate, and/or packet drop, and so forth. According to some exemplary embodiments, objective solution analyzer 230 may select from geo-bins output from geo-bin data mapper 225.

According to an exemplary embodiment, for each geo-bin or catalogued new RAN device placement site, objective solution analyzer 230 may apply an optimization function aligned with the objective criterion or criteria. For example, when the objective criteria is to maximize population covered, objective solution analyzer 230 may iteratively evaluate each geo-bin (in terms of maximizing population covered) along with correlated data (e.g., new RAN device design build, radio coverage, etc.), and rank the solutions associated with geo-bins/new RAN device placement sites, predicted coverage areas, etc., that may best satisfy the objective criterion.

FIG. 4B is a diagram illustrating an exemplary process 450 of an exemplary embodiment of the RAN KPI geographic normalization, decluster, and selection service according to an exemplary scenario in which the objective criterion is maximizing population covered. As illustrated, exemplary radio coverages are shown, which include radio coverages A, B, C, D, and E. The shape, sizes, and positions relative to the geo-bins are exemplary. The base data includes radio coverages and geo-bins associated with various data (e.g., performance metric data, etc.), as described herein. As further illustrated, according to process 450, objective solution analyzer 230 may iteratively select solutions associated with geo-bins and radio coverage areas that best satisfy the objective criterion. For example, in the first iteration, objective solution analyzer 230 may select radio coverage C, in the second iteration (which takes into account the impact of a new RAN device build in radio coverage C, objective solution analyzer 230 may select radio coverage A (with radio coverage C already selected), and in the nth iteration, radio coverage E may be selected (with radio coverages C and A already selected). The selected radio coverages may also include new RAN device designs/builds, etc., as described herein. Objective solution analyzer 230 may apply various types of constraints during process 450, such as satisfying a minimum number of people covered, cost (e.g., network resources, monetary, etc.), and/or other types of configurable criterion according to this example. Objective solution analyzer 230 may perform process 450 in parallel across multiple and disparate geographic areas. According to some exemplary embodiments, each geographic area may be dissimilar to each other (e.g., in terms of RAN devices, radio coverage, terrain, etc.) that may prevent solutions from “bumping” into each other or overlapping, which may be counterproductive.

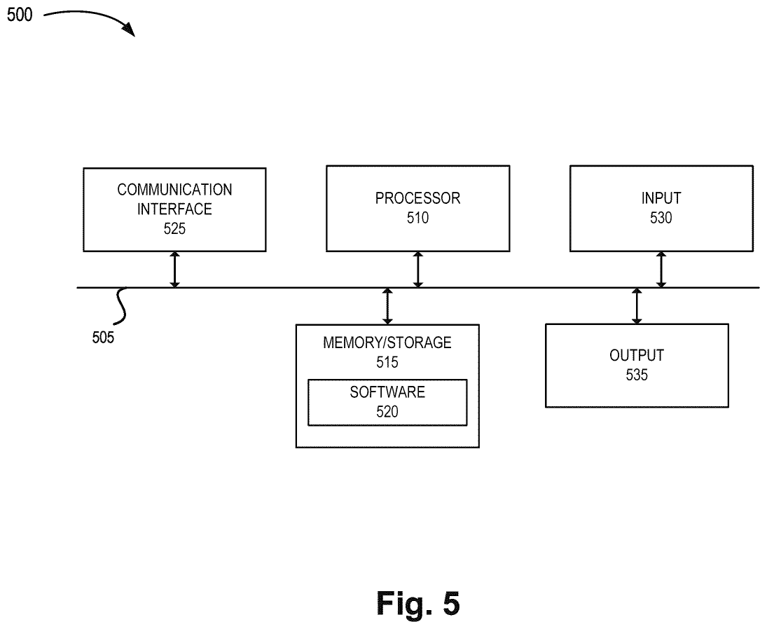

FIG. 5 is a diagram illustrating exemplary components of a device 500 that may be included in one or more of the devices described herein. For example, device 500 may correspond to access device 107, core device 122, network management device 125, end device 130, end devices 135, and/or other types of devices, as described herein. As illustrated in FIG. 5, device 500 includes a bus 505, a processor 510, a memory/storage 515 that stores software 520, a communication interface 525, an input 530, and an output 535. According to other embodiments, device 500 may include fewer components, additional components, different components, and/or a different arrangement of components than those illustrated in FIG. 5 and described herein.

Bus 505 includes a path that permits communication among the components of device 500. For example, bus 505 may include a system bus, an address bus, a data bus, and/or a control bus. Bus 505 may also include bus drivers, bus arbiters, bus interfaces, clocks, and so forth.

Processor 510 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 510 may be implemented as hardware (e.g., a microprocessor, etc.), a combination of hardware and software (e.g., a SoC, an ASIC, etc.), may include one or multiple memories (e.g., cache, etc.), etc.

Processor 510 may control the overall operation, or a portion of operation(s) performed by device 500. Processor 510 may perform one or multiple operations based on an operating system and/or various applications or computer programs (e.g., software 520). Processor 510 may access instructions from memory/storage 515, from other components of device 500, and/or from a source external to device 500 (e.g., a network, another device, etc.). Processor 510 may perform an operation and/or a process based on various techniques including, for example, multithreading, parallel processing, pipelining, interleaving, learning, model-based, etc.

Memory/storage 515 includes one or multiple memories and/or one or multiple other types of storage mediums. For example, memory/storage 515 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 515 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 515 may be external to and/or removable from device 500, such as, for example, a Universal Serial Bus (USB) memory stick, a dongle, a hard disk, mass storage, off-line storage, or some other type of storing medium. Memory/storage 515 may store data, software, and/or instructions related to the operation of device 500.

Software 520 includes an application or a program that provides a function and/or a process. As an example, with reference to network management device 125, software 520 may include an application that, when executed by processor 510, provides a function and/or a process of RAN KPI geographic normalization, decluster, and selection service, as described herein. Additionally, with reference to end device 130, software 520 may include an application that, when executed by processor 510, provides a function and/or a process of RAN KPI geographic normalization, decluster, and selection service, as described herein. Software 520 may also include firmware, middleware, microcode, hardware description language (HDL), and/or other form of instruction. Software 520 may also be virtualized. Software 520 may further include an operating system (OS) (e.g., Windows, Linux, Android, proprietary, etc.).

Communication interface 525 permits device 500 to communicate with other devices, networks, systems, and/or the like. Communication interface 525 includes one or multiple wireless interfaces and/or wired interfaces. For example, communication interface 525 may include one or multiple transmitters and receivers, or transceivers. Communication interface 525 may operate according to a protocol stack and a communication standard. Communication interface 525 may include various processing logic or circuitry (e.g., multiplexing/de-multiplexing, filtering, amplifying, converting, error correction, application programming interface (API), etc.). Communication interface 525 may be implemented as a point-to-point interface, a service-based interface, or a reference interface, for example.

Input 530 permits an input into device 500. For example, input 530 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 535 permits an output from device 500. For example, output 535 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, etc.). Device 500 may be implemented in the same manner. For example, device 500 may be instantiated, created, deleted, or some other operational state during its life-cycle (e.g., refreshed, paused, suspended, rebooting, or another type of state or status), using well-known virtualization technologies.

Device 500 may perform a process and/or a function, as described herein, in response to processor 510 executing software 520 stored by memory/storage 515. By way of example, instructions may be read into memory/storage 515 from another memory/storage 515 (not shown) or read from another device (not shown) via communication interface 525. The instructions stored by memory/storage 515 cause processor 510 to perform a function or a process described herein. Alternatively, for example, according to other implementations, device 500 performs a function or a process described herein based on the execution of hardware (processor 510, etc.).

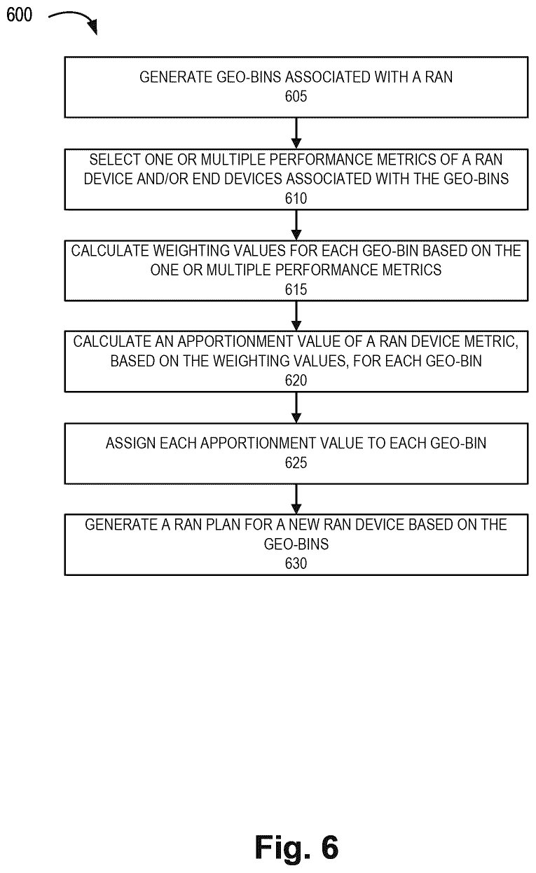

FIG. 6 is a flow diagram illustrating an exemplary process 600 of an exemplary embodiment of RAN KPI geographic normalization, decluster, and selection service. According to an exemplary embodiment, network management device 125 may perform a step of process 600. According to other exemplary embodiments, end device 130 or end device 130 and network management device 125 may perform a step of process 600. According to an exemplary implementation, processor 510 executes software 520 to perform the step of process 600, as described herein. Alternatively, the step may be performed by execution of only hardware. For purposes of description of process 600, network management device 125, end device 130 and network management device 125, and end device 130 may be referred to simply as a device.

Referring to FIG. 6, in block 605, a device may generate geo-bins associated with a RAN. For example, geospatial normalizer 205 of the device may perform the geographic normalization service with respect to geo-bins, as described herein. Geospatial normalizer 205 may calculate the geo-bins based on calculated RF coverage associated with a RAN. RF propagation analyzer 220 may include identifying which geo-bins should or could be associated with the RAN.

In block 610, the device may select one or multiple performance metrics of access device 107 and/or end devices 135 associated with the normalized geo-bins. For example, geo-bin data mapper 225 of the device may select a performance metric that may be a root cause, contributor, a statistical relationship, and/or the like to non-geographic network data, as described herein.

In block 615, the device may calculate weighting values for each normalized geo-bin based on the one or multiple performance metrics. For example, geo-bin data mapper 225 of the device may calculate the weight based on the performance metric value associated with the geo-bin (e.g., an RSRP value), a relationship between different performance metric values, such as a ratio (e.g., FDV/UPTP), or some other mathematical operation applied to the one or multiple performance metric value(s) (e.g., addition, subtraction, division, multiplication with a scalar, percentage, etc.).

In block 620, the device may calculate an apportionment value of a RAN device metric, based on the weighting values, for each geo-bin. For example, geo-bin data mapper 225 of the device may calculate the apportionment value based on expression (1), as described herein.

In block 625, the device may assign each apportionment value to each normalized geo-bin. For example, geo-bin data mapper 225 of the device may tag or correlate each apportionment value to their respective normalized geo-bin, as described herein.

In block 630, the device may generate a RAN plan for a new RAN device based on the normalized geo-bins, which includes the apportionment values, as described herein.

FIG. 6 illustrates an exemplary embodiment of a process of RAN KPI geographic normalization, decluster, and selection service, however, according to other exemplary embodiments, the RAN KPI geographic normalization, decluster, and selection service may perform additional operations, fewer operations, and/or different operations than those illustrated and described. For example, the device may provide the RAN plan, which may be used by a network operator or another type of entity to implement or construct the new RAN device at the selected geo-bin site.

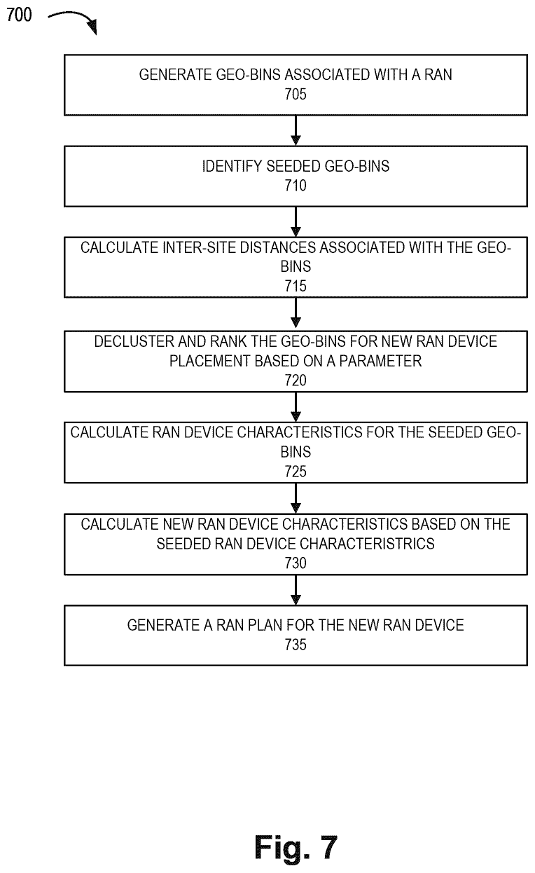

FIG. 7 is a flow diagram illustrating an exemplary process 700 of an exemplary embodiment of RAN KPI geographic normalization, decluster, and selection service. According to an exemplary embodiment, network management device 125 may perform a step of process 700. According to other exemplary embodiments, end device 130 or end device 130 and network management device 125 may perform a step of process 700. According to an exemplary implementation, processor 510 executes software 520 to perform the step of process 700, as described herein. Alternatively, the step may be performed by execution of only hardware. For purposes of description of process 700, network management device 125, end device 130 and network management device 125, and end device 130 may be referred to simply as a device.

Referring to FIG. 7, in block 705, the device may generate geo-bins associated with a RAN. For example, geospatial normalizer 205 of the device may perform the geographic normalization service with respect to geo-bins, as described herein.

In block 710, the device may identify seeded geo-bins. For example, RAN device placer 210 of the device may identify seeded locations, which may include geo-bins with existing RAN devices, geo-bins identified for future RAN device builds, and so forth, as described herein. The device may also identify non-seeded geo-bins, as described herein.

In block 715, the device may calculate inter-site distances associated with the geo-bins. For example, RAN device placer 210 of the device may calculate different densities based on distance d and the associated geo-bins (e.g., geo-bins 305).

In block 720, the device may decluster and rank the geo-bins for new RAN device placement based on a parameter. For example, RAN device placer 210 of the device may evaluate, iteratively sort, and rank the geo-bins based on one or multiple objective criteria. The iterative sorting approach may include sorting a set of geo-bins based on the one or multiple objective criteria and selecting the best geo-bins from the set, and a next iteration may include sorting another set of geo-bins (taking into account all previous iterations) based on the one or multiple objective criteria. In this way, the declustering may deduplicate geo-bins in subsequent iterations. As described herein, an objective criterion may relate to optimizing a performance metric (e.g., throughput, etc.) and/or another type of criterion pertaining to a wireless service (e.g., radio coverage, population density, etc.), as described herein. RAN device placer 210 may select one or multiple of the ranked geo-bins as candidate site(s) for new RAN device(s). For example, RAN device placer 210 may select a subset of the ranked geo-bins based on an optimization factor (e.g., threshold value) pertaining to the objective criterion or criteria.

In block 725, the device may calculate RAN device characteristics for the seeded geo-bins. For example, RAN device designer 215 of the device may calculate radio attributes associated with an antenna, region, equipment vendor, site type, morphology, and other factors in relation to existing and planned RAN devices.

In block 730, the device may automatically calculate new RAN device characteristics based on the seeded RAN device characteristics. For example, RAN device designer 215 of the device may calculate in an automated manner, new RAN device builds based on the existing/planned RAN device characteristics, the proximity of the selected geo-bins for new RAN device builds to the geo-bins of the seeded RAN devices, as described herein.

In block 735, the device may generate a RAN plan for the new RAN device. For example, RF propagation analyzer 220, geo-bin data mapper 225, and/or objective solution analyzer 230 of the device may generate the RAN plan based on the automated design of the new RAN device(s) associated with candidate geo-bin(s).

FIG. 7 illustrates an exemplary embodiment of a process of RAN KPI geographic normalization, decluster, and selection service, however, according to other exemplary embodiments, the RAN KPI geographic normalization, decluster, and selection service may perform additional operations, fewer operations, and/or different operations than those illustrated and described. For example, the device may provide the RAN plan, which may be used by a network operator or another type of entity to implement or construct the new RAN device at the selected geo-bin site.

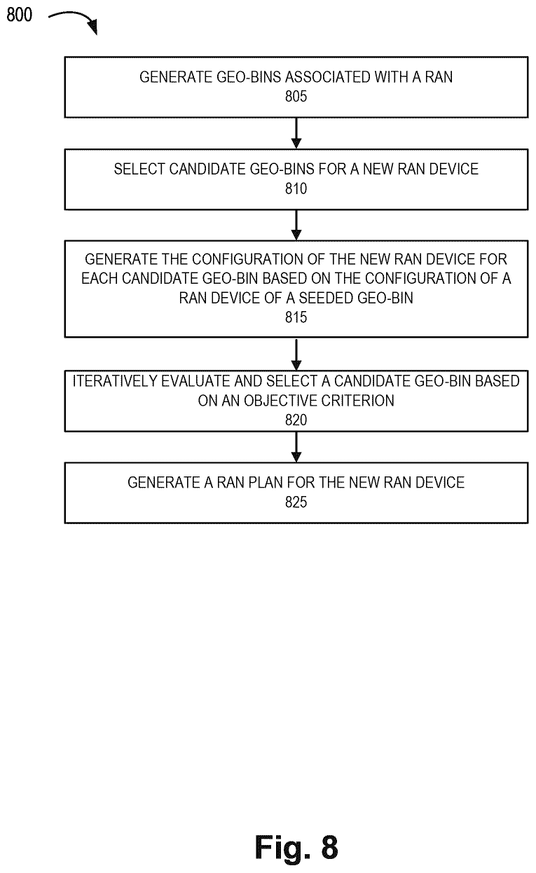

FIG. 8 is a flow diagram illustrating an exemplary process 800 of an exemplary embodiment of RAN KPI geographic normalization, decluster, and selection service. According to an exemplary embodiment, network management device 125 may perform a step of process 800. According to other exemplary embodiments, end device 130 or end device 130 and network management device 125 may perform a step of process 800. According to an exemplary implementation, processor 510 executes software 520 to perform the step of process 800, as described herein. Alternatively, the step may be performed by execution of only hardware. For purposes of description of process 800, network management device 125, end device 130 and network management device 125, and end device 130 may be referred to simply as a device.

Referring to FIG. 8, in block 805, the device may generate geo-bins associated with a RAN. For example, geospatial normalizer 205 of the device may perform the geographic normalization service of the geo-bins, as described herein. According to some exemplary embodiments, geo-bin data mapper 225 may map apportioned values to the normalized geo-bins, as described herein.

In block 810, the device may select candidate geo-bins for a new RAN device. For example, RAN device placer 210 of the device may evaluate and rank the geo-bins based on one or multiple objective criteria.

In block 815, the device may generate the configuration for the new RAN device for each candidate geo-bin based on the configuration of a RAN device of a seeded geo-bin. For example, RAN device designer 215 of the device may calculate in an automated manner, new RAN device builds based on the existing/planned RAN device characteristics, the proximity of the selected geo-bins for new RAN device builds to the geo-bins of the seeded RAN devices, as described herein.

In block 820, the device may iteratively evaluate and select a candidate geo-bin based on an objective criterion. For example, objective solution analyzer 230 of the device may iteratively determine the candidate geo-bin that may best satisfy the objective criterion, such as a performance metric and/or another configurable criterion, as described herein, and constraint, for a new RAN device. According to some exemplary embodiments, the device may provide an interface that enables a user of the device to enter the objective criterion.

In block 825, the device may generate a RAN plan for the new RAN device. For example, the device may generate the RAN plan based on the automated design of the new RAN device(s) and the candidate geo-bin(s) that best satisfy the objective criterion and constraint, as described herein.

FIG. 8 illustrates an exemplary embodiment of a process of the RAN KPI geographic normalization, decluster, and selection service, however, according to other exemplary embodiments, the RAN KPI geographic normalization, decluster, and selection service may perform additional operations, fewer operations, and/or different operations than those illustrated and described. For example, the device may provide the RAN plan, which may be used by a network operator or another type of entity to implement or construct the new RAN device at the selected geo-bin site.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive. According to some exemplary embodiments, one or more components and/or sub-services may be used for network planning regarding a network other than a RAN, such as a core network, an X-haul network, an optical/fiber network, fixed wireless with fiber, and the like.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 6-8, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 510, etc.), or a combination of hardware and software (e.g., software 520).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 510) of a device. A non-transitory storage medium includes one or more of the storage mediums described in relation to memory/storage 515. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
generating, by a device, geo-bins associated with a radio coverage area of a radio access network (RAN);
selecting, by the device, one or more performance metrics of at least one of a RAN device or end devices associated with the geo-bins;
calculating, by the device, a weighting value for each of the geo-bins based on the one or more performance metrics;
calculating, by the device based on the weighting values of the geo-bins, an apportionment value of a RAN device metric of the RAN device, for each of the geo-bins; and
generating, by the device, a RAN plan of a new RAN device based on the geo-bins that include the apportionment values.

2. The method of claim 1, wherein the calculating of the apportionment value comprises:
calculating, by the device, a ratio value between a first apportionment value associated with a first geo-bin of the geo-bins and a second apportionment value associated with a summation of the apportionment values of the geo-bins.

3. The method of claim 1, further comprising:
generating, by the device based on an antenna design of an existing RAN device that matches a density value associated with the new RAN device, an antenna design of the new RAN device.

4. The method of claim 1, further comprising:
calculating, by the device, a first radio frequency (RF) propagation modeling of the RAN device; and
calculating, by the device based on the first RF propagation modeling, a second RF propagation modeling for the new RAN device.

5. The method of claim 1, further comprising:
receiving, by the device, one or more objective criteria;
iteratively calculating, by the device, first geo-bins of the geo-bins, wherein the first geo-bins satisfy the one or more objective criteria and are candidate locations for new RAN devices; and
ranking, by the device, the first geo-bins based on an optimization of the one or more objective criteria.

6. The method of claim 1, wherein the selecting comprises:
selecting, by the device, the one or more performance metrics based on a causal or a correlative relationship with the RAN device metric.

7. The method of claim 1, wherein the RAN device metric relates to dropped calls, wait time, or network resource utilization of the RAN device.

8. The method of claim 1, wherein the one or more performance metrics relate to at least one of throughput, latency, or packet error rate.

9. A device comprising:
a processor configured to:
generate geo-bins associated with a radio coverage area of a radio access network (RAN);
select one or more performance metrics of at least one of a RAN device or end devices associated with the geo-bins;
calculate a weighting value for each of the geo-bins based on the one or more performance metrics;
calculate, based on the weighting values of the geo-bins, an apportionment value of a RAN device metric of the RAN device, for each of the geo-bins; and
generate, by the device, a RAN plan of a new RAN device based on the geo-bins that include the apportionment values.

10. The device of claim 9, wherein the processor is further configured to:
calculate a ratio value between a first apportionment value associated with a first geo-bin of the geo-bins and a second apportionment value associated with a summation of the apportionment values of the geo-bins.

11. The device of claim 9, wherein the processor is further configured to:
generate, based on an antenna design of an existing RAN device that matches a density value associated with the new RAN device, an antenna design of the new RAN device.

12. The device of claim 9, wherein the processor is further configured to:
calculate a first radio frequency (RF) propagation modeling of the RAN device; and
calculate, based on the first RF propagation modeling, a second RF propagation modeling for the new RAN device.

13. The device of claim 9, wherein the processor is further configured to:
receive one or more objective criteria;
iteratively calculate first geo-bins of the geo-bins, wherein the first geo-bins satisfy the one or more objective criteria and are candidate locations for new RAN devices; and
rank the first geo-bins based on an optimization of the one or more objective criteria.

14. The device of claim 9, wherein, when selecting, the processor is further configured to:
select the one or more performance metrics based on a causal or a correlative relationship with the RAN device metric.

15. The device of claim 9, wherein the RAN device metric relates to dropped calls, wait time, or network resource utilization of the RAN device.

16. The device of claim 9, wherein the one or more performance metrics relate to at least one of throughput, latency, or packet error rate.

17. A non-transitory computer-readable storage medium storing instructions executable by a processor of a device, wherein the instructions are configured to:
generate geo-bins associated with a radio coverage area of a radio access network (RAN);
select one or more performance metrics of at least one of a RAN device or end devices associated with the geo-bins;
calculate a weighting value for each of the geo-bins based on the one or more performance metrics;
calculate, based on the weighting values of the geo-bins, an apportionment value of a RAN device metric of the RAN device, for each of the geo-bins; and
generate, by the device, a RAN plan of a new RAN device based on the geo-bins that include the apportionment values.

18. The non-transitory computer-readable storage medium of claim 17, wherein the instructions further comprise instructions configured to:
calculate a ratio value between a first apportionment value associated with a first geo-bin of the geo-bins and a second apportionment value associated with a summation of the apportionment values of the geo-bins.

19. The non-transitory computer-readable storage medium of claim 17, wherein the instructions further comprise instructions configured to:
receive one or more objective criteria;
iteratively calculate first geo-bins of the geo-bins, wherein the first geo-bins satisfy the one or more objective criteria and are candidate locations for new RAN devices; and
rank the first geo-bins based on an optimization of the one or more objective criteria.

20. The non-transitory computer-readable storage medium of claim 17, wherein the one or more performance metrics relate to at least one of throughput, latency, or packet error rate.
